(19) United States
(12) Patent Application Publication
(10) Pub. No.: US 2014/0272501 A1
(43) Pub. Date: Sep. 18, 2014

(54) BATTERY PACK MECHANICAL DESIGN TO ACCOMMODATE LEAD-ACID AND LITHIUM BATTERY WITH SAME PACKAGING

(71) Applicant: WM GreenTech Automotive Corp, McLean, VA (US)

(72) Inventors: MATT O'BRIEN, Hermosa Beach, CA (US); Youssef Daou, Southaven, MS (US)

(73) Assignee: WM GreenTech Automotive Corp, Tunica, MS (US)

(21) Appl. No.: 14/212,209

(22) Filed: Mar. 14, 2014

Related U.S. Application Data
(60) Provisional application No. 61/790,067, filed on Mar. 15, 2013.

(51) Int. Cl. H01M 2/10

(52) U.S. Cl. CPC H01M 2/1077; H01M 2/1083
USPC 429/90

(57) ABSTRACT

An electric vehicle has a housing that can interchangeably accommodate at least two different types of batteries therein. A plurality of modules are provided within the housing. Each module has a plurality of batteries of a first type arranged into a first battery module that is interchangeable with a plurality of batteries of a second, different type arranged into a second battery module. Both types can supply power to the electric vehicle. Because each the first and second battery modules have similar shape, the housing allows for a modular design, use of different types of batteries, and easy removal and replacement during assembly. A battery management system is also provided to monitor the modules.

### CROSS REFERENCE TO RELATED APPLICATION

This application is related to and claims priority to U.S. Provisional Patent Application Ser. No. 61/790,067, filed Mar. 15, 2013, which is hereby incorporated by reference herein in its entirety.

### BACKGROUND

1. Field

The present disclosure is generally related to a battery pack design for a vehicle. More specifically, it relates to a housing capable of interchangeably accommodating more than one type of battery, such as lead-acid or lithium battery packs.

2. Description of Related Art

Electric vehicles use batteries to provide power to a motor, brakes, and the like. Such batteries are installed in the vehicle for connection to contacts or fittings to deliver power to an associated device or system.

In general, it is known to insert and remove batteries relative to vehicles as modular packs. Batteries are typically configured for installation into a predetermined location in the vehicle. Historically, battery packs, such as lead acid and lithium batteries, require very different packaging solutions and system components, along with different types of assembly equipment.

### SUMMARY

One aspect of this disclosure provides a housing configured to interchangeably accommodate at least two different types of batteries. The housing includes: a body having bottom side, front side, left side, right side, and back side; a lid removably connected to the body to provide access therein; a plurality of modules provided within the body, each module having a plurality of batteries of a first type arranged into a first battery module that is interchangeable with a plurality of batteries of a second type arranged into a second battery module. The second type of batteries is different from the first type of batteries, and the first and second battery modules have similar shape. The housing also includes positive and negative contacts for connection with batteries provided in the body, and a battery management system configured to monitor the plurality of modules.

Another aspect of this disclosure includes an electric vehicle including: a housing configured to interchangeably accommodate at least two different types of batteries. The housing includes a plurality of modules provided within the body, each module comprising a plurality of batteries of a first type arranged into a first battery module that is interchangeable with a plurality of batteries of a second type arranged into a second battery module. The second type of batteries is different from the first type of batteries and the first and second battery modules have similar shape. The housing has a body having bottom side, front side, left side, right side, and back side and a lid removably connected to the body to provide access to the modules therein, as well as positive and negative contacts provided on the housing for connection with batteries provided in the body and a battery management system configured to monitor the plurality of modules. Both the first type and the second type of batteries are each separately configured to supply power to the electric vehicle.

Other features and advantages of the present disclosure will become apparent from the following detailed description, the accompanying drawings, and the appended claims.

### BRIEF DESCRIPTION OF THE DRAWINGS

FIG. 1 is an oblique front view of an embodiment of a vehicle body.

FIG. 2 is a detailed top view of a housing configured to accommodate more than one type of battery, in accordance with an embodiment, with lithium battery packs mounted therein.

FIGS. 3-5 illustrate alternate configurations of lithium battery packs mounted in the housing of FIG. 2, in accordance with embodiments herein.

FIGS. 6-7 illustrate alternate configurations of lead acid battery packs mounted in the housing of FIG. 2, in accordance with embodiments herein.

FIG. 8 is a perspective view of a housing with a lid, in accordance with embodiments herein.

### DETAILED DESCRIPTION OF THE PREFERRED EMBODIMENT(S)

Because different types of vehicle batteries historically require very different packaging solutions and system components, along with different types of assembly equipment, the inventors have determined that it is beneficial, among other reasons, to establish a streamlined design for mounting and housing batteries. Accordingly, disclosed herein is a housing capable of interchangeably accommodating more than one type of battery. In particular, the housing enables a battery packaging solution that allows multiple and different configurations of different types of batteries in the same housing (at different times). The innovative packing solution allows for usage of common assembly equipment when building the housing for battery packs or modules.

In the embodiments disclosed herein, two different types of batteries are described for mounting in the housing, namely, lead-acid and lithium batteries. However, it should be understood that such types of batteries are not meant to be limiting. That is, it is also envisioned that other types of batteries may be provided in the housing. In an embodiment, the type of batteries provided in the housing are configured for mounting in and use with an electric vehicle.

For example, FIG. 1 illustrates an example of an electric vehicle 10 comprising a vehicle body 12 with a housing 14 therein (also referred to throughout as battery housing 14; shown in phantom lines in FIG. 1) for receiving battery packs or modules. In the exemplary illustrated embodiment, housing 14 is provided in a front end of the vehicle body, e.g., on the vehicle chassis. However, it should be understood that the battery housing 14 can be placed in one or more different locations in the vehicle, including a rear end of the vehicle. Housing 14 can be easily accessible for maintenance and service, as well as for changing battery modules.

Housing 14, as shown in FIG. 2, is configured to receive and house at least two different types of batteries, at separate times. That is, either a first type or a second type of batteries are provided in housing and used with the electric vehicle 10. Typically, a different package design and system components (assembled by different types of assembly equipment) are used for each type of battery that is configured for mounting in a vehicle. Thus, different housings and equipment are used. However, housing 14 may allow for different types and capacities of batteries to be provided in the same package in a vehicle, and without change of major components. It also may allow for a reduction costs by reducing a need for full equipment replacement and time for doing the same. Housing 14 can be used in any electric vehicle where cost may be a concern and where there is a desire or need to offer a number of different types of batteries for use therein.

As shown in FIGS. 2 and 8, housing 14 comprises a body 16 having a bottom side, a front side 20, a left side 22, a right side 24, and a back side 26. A lid 28, shown in FIG. 8, is removably connected to the body 16 to provide access to contents therein. The lid 28 can be attached via flanges, 38 or other connection devices, using attachment devices such as fasteners or nuts and bolts. One or more ribs 40 extend between front side 20 and back side 26 to form compartments in the housing and to provide additional rigidity to housing 14. The rib(s) 40, the lid 28, and/or a bottom side of housing 14 can be used for connection to the vehicle 10.

Housing 14 is configured to interchangeably accommodate batteries in the form of battery modules or packs. A plurality of a first type of modules 30 are provided within the body 16 of housing 14. For example, as shown in FIGS. 2-5 and FIG. 8, each module 30 comprises a plurality of batteries 32 of a first type arranged into a first battery module. Each of the first battery modules 30 are interchangeable with a plurality of batteries 36 of at least a second type arranged into a second battery module 34, as such the modules shown in FIGS. 6-7. The at least second type of batteries 36 is different from the first type of batteries 32. However, the first and second battery modules 30 and 34 each have a similar shape. The similar shape of the battery modules provides a modular design that enables use of housing 14 with any type of battery and in any location in electric vehicle 10. The modules are completely interchangeable and removal of each of the battery modules can be accomplished easily and with minimal time and effort. As will also be further recognized through the description below, the layout and packaging of the modules may also attribute to the modularity of housing 14.

The batteries or modules in housing 14 are designed to be associated with any number of devices in the vehicle. For example, the batteries may be designed to supply power to an electric motor or an electric braking system. More specifically, both the first type and the at least second type of batteries are each separately configured to supply power to the electric vehicle. The application and use of power from batteries is not meant to be limiting.

Electrical connection of each of the modules can be established upon installation. For example, positive and negative terminal contacts 42 for connection with modules is also provided in the body 16. In an embodiment, the positive and negative terminal contacts 42 are provided on an L-shaped bar (see FIG, 2) positioned above the modules therein. This allows for connection of the battery modules 30, for example, in a parallel configuration, as well as for the addition of battery modules within the housing (e.g., when oriented in a direction that is perpendicular to the direction shown). Positive and negative terminals 42 are attached to contactors, which are attached to the internal structure via bus bars. A contactor switch 44 is also provided within housing 14.

Further, in an embodiment, the electronic module system (EMS) 46 associated with the type of battery modules positioned in housing 14 can be provided in housing 14. The boxes or devices associated with the EMS 46 are sized for each of the different configurations of batteries. The EMS 46 is typically manufacturer defined. The EMS 46 provides safety and functionality features, as well as management of the battery pack including working with other devices and systems to show (e.g., via a display) the state of charge (SOC), capacity, voltage, temperature, current, power, and/or other features associated with the modules and/or battery pack. It can cut off power of the battery given to the car once/if the voltage reaches some limit, for example, or once/if temperature exceeds some limits. The EMS 46 can also controls the contactors, for example, as well as starting the power given to the car. Other features and functions of the EMS should be understood by one of ordinary skill in the art.

Housing 14 can also include a battery management system (BMS) 48 configured to monitor the plurality of battery modules. For example, BMS 48 can be used to monitor the temperature and voltage of the batteries, based on its type. BMS 48 can communicate with the electric vehicle 10 regarding an amount of power and/or control based on predetermined monitoring settings. The BMS 48 can include any number of devices associated therewith. The number of devices in the BMS 48 can be adjusted based on the number of battery modules in the housing 14. The BMS provide safety and functionality features, as well as additional management of the battery pack. It can control the contactors for the safety, and ground fault, as well as can render the pack electrically inactive when open and provide a manual disconnect switch that will divide the pack into two and makes it electrically to ground. It can control the SOC, SOH, capacity, voltage, temperature, current, and power, for example, that are supplied to the vehicle. Also, it communicates critical parameters with the EMS. It can stop the battery from working once/if the voltage and/or temperature is below a lower limit, or above a higher limit. Other features and functions of the BMS should be understood by one of ordinary skill in the art.

Center rib 40 may also be used for mounting electronics such as EMS 46 and/or BMS 48 or other devices thereon (e.g., shown in FIGS, 6-7) for connection and/or communication with the battery modules in housing 14 and/or other management devices.

In an embodiment, the types of batteries that housing 14 is configured to accommodate are (at least) lithium batteries and lead acid batteries, Lithium battery packs are generally more expensive (e.g., four times more expensive) and lighter than lead acid batteries. However, lead acid batteries tend to have a longer life span as compared to lithium batteries.

For example, FIG. 2 shows, in detail, a plurality of lithium battery modules 30. Each lithium (first type) battery module 30 comprises a subassembly of lithium batteries in the form of cells 50. Each of these battery cells 50 are connected via junctions or connector bars 52. Connector bars 52 are made of a material such as copper. Any number of lithium battery cells 50 can be connected together to form a battery module 30. In accordance with an embodiment, the number of battery cells of a first type that are connected together to form a pack or a module is determined based on a size of one or more battery cells of the second type. In an embodiment, smaller lithium cells are pre-packaged into a form or shape that is similar to a single lead acid cell (e.g., a large 8D cell). That is, because of the size of the lithium battery cells, multiple lithium batteries can be connected to approximate a size of a lead acid battery (e.g., shown in FIG. 7). For example, in one embodiment, shown in FIG, 2, the number of lithium battery cells 50 that are connected via connector bars 52 to form a battery module 30 is twelve. However, the number of cells used to form a battery module of either a first or a second type are not meant to be limiting.

Moreover, the positioning of the cells to form a module is not limiting, In one embodiment, the battery cells of each module are arranged in series (e.g., see FIG. 2).

Depending on the configuration of each of the battery modules 30 in housing 14, one or more jumpers 54 are connected to battery modules 30. That is, two battery modules 30 are connected together via jumpers 54 to form a pair. In FIG. 2, three pairs of battery modules 30 are provided in housing 14 (i.e., six modules 30). The battery modules 30 are inserted in symmetry in housing 14 and are connected in a parallel configuration and to each other via jumpers 54. Each jumper 54 is positioned to extend across center rib 40.

However, as shown in FIGS. 3-5, the number of battery packs or modules 30 mounted in housing 14 are not limiting. The number of battery modules 30 can be based on design choice and/or desired battery capacity. Accordingly, housing 14 can also have any number of battery pack configurations. In an embodiment, the plurality of modules provided within the body is an even number such that the battery modules are paired. For example, housing 14 may include three pairs of battery modules 30 connected in parallel as shown in FIGS. 2 and 5 (total of 6 battery modules 30 in housing 14). Also, less battery packs may be provided in housing 14. FIG. 3 illustrates an example of a configuration that comprises a single pair of battery modules 30 (two modules) in housing 14. The battery modules 30 are provided in symmetry (e.g., in the illustration, in a middle or center position of housing 14) such that they can be connected via a jumper 54 over the center rib 40. FIG. 4 illustrates an example of a configuration that comprises a two pairs of battery modules 30 (four modules) in housing 14. The battery modules 30 are provided in symmetry (e.g., in the illustration, adjacent front and back sides 20 and 26 housing 14) and each pair is connected via a jumper 54 over the center rib 40.

As noted above, the battery packs are connected to any electronics on the center rib 40 and to the battery management system 48. The size and number of devices on center rib 40 and/or in BMS 48 can be change based on the number of modules provided in housing 14 (see, e.g., FIG. 3 and FIG. 4).

Further, more than three pairs of battery modules 30 may be mounted in housing 14. For example, battery modules 30 may be smaller in size (e.g., should they contain less individually connected battery cells 50) or positioned in manner that is parallel with center rib 40 (perpendicular to the direction modules 30 are shown). Additionally and/or alternatively, additional structural members like central rib 40 may be provided along housing, allowing for additional rows and pairs of battery modules (e.g., two ribs can be provided in housing 14). Accordingly, the number of battery pack modules used in housing 14 may be a matter of design choice based on size, shape, types, etc. and/or the device or system the batteries are used with.

It should be understood that one or more supports, insulation, or padding, represented by element 56, may be provided within housing 14, e.g., between the pluralities of modules (no matter their type). For example, in an embodiment, low cost insert(s) made of a support material (such as foam) are used around and/or between battery packs to fill open spaced areas in housing 14, and to provide support and padding to the battery packs (no matter their type) when housed in housing 14. FIG. 4 shows an example of a location of such devices 56. The material used to support the battery modules (of either type) is not limited.

FIGS. 6 and 7 illustrate alternate configurations of housing 14 with second type of battery modules 34 therein. In accordance with an embodiment, such modules 34 are lead acid battery modules. FIG, 6 illustrates six smaller battery packs mounted in housing 14, while FIG. 7 illustrates six larger battery packs therein. The cells as shown in FIGS. 6 and 7 are in series. The BMS is attached to top and bottom cells to provide voltage. From the positive side, a current sensor is provided between the BMS and the cells to provide a current measurement. Also, the BMS is attached to thermistors to read the temperature of the cells in the housing 14. The BMS acts based on the determined temperature value by either keeping the battery pack functioning, or stopping the battery pack from discharging/charging (e.g., by opening contactors).

The systems, connections, hardware, software, etc. associated with each of the types of battery modules may be switched when the battery modules themselves are changed and/or provided during assembly. In an embodiment, the battery management system 48 used with the lithium modules 30 is removed. In another embodiment, the battery management system used with lead acid battery packs is not included in housing 14.

The examples shown in FIGS. 2-8 allows for at least five different configurations of batteries in the same housing using two different types of batteries (namely, lead-acid and lithium batteries). Such configurations illustrate exemplary battery packaging solutions and designs that accommodate two different types of batteries in the same box that can be assembled using similar assembly equipment.

For example, it is envisioned that housing 14 is configured to accommodate a plurality of battery modules of a third type, the third type of batteries being different from the first type and the second type of batteries. Each module may include a plurality of batteries of the third type being interchangeable with the plurality of batteries of the first type and/or the second type. The third type of batteries may have different chemistries than lead acid or lithium batteries. The third type of batteries may include, but are not limited to, lithium titanate and/or NMC batteries.

The herein described housing acts as a storage compartment to facilitate interchange of different types of battery packs therein and is used in an electric vehicle including an electric motor and a vehicle body. Providing the package design of the battery modules in a similar shape for mounting in housing 14 allows for the usage of common assembly equipment. The same equipment can be used for installation and production. Accordingly, the cost for production and assembly may be made easier, faster, and cheaper. Also, the manufacturer can offer a variety of battery module configurations in the electric vehicle 10,

While the principles of the disclosure have been made clear in the illustrative embodiments set forth above, it will be apparent to those skilled in the art that various modifications may be made to the structure, arrangement, proportion, elements, materials, and components used in the practice of the invention.

It will thus be seen that the features and advantages of this disclosure has been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A housing configured to interchangeably accommodate at least two different types of batteries comprising:
a body comprising bottom side, front side, left side, right side, and back side;
a lid removably connected to the body to provide access therein;
a plurality of modules provided within the body, each module comprising a plurality of batteries of a first type arranged into a first battery module that is interchangeable with a plurality of batteries of a second type arranged into a second battery module, the second type of batteries being different from the first type of batteries and the first and second battery modules comprising similar shape;
positive and negative contacts for connection with batteries provided in the body, and
a battery management system configured to monitor the plurality of modules.

2. The housing according to claim 1, wherein the types of batteries are lithium batteries and lead acid batteries.

3. The housing according to claim 1, wherein the plurality of modules are mounted in symmetry in the body.

4. The housing according to claim 1, wherein the plurality of modules are arranged in a parallel configuration.

5. The housing according to claim 4, wherein the batteries of each module are arranged in series.

6. The housing according to claim 1, wherein the plurality of modules provided within the body is an even number.

7. The housing according to claim 1, further comprising padding or insulation between the plurality of modules.

8. The housing according to claim 1, wherein the housing is configured to accommodate a plurality of battery modules of a third type, each module comprising a plurality of batteries of the third type being interchangeable with the plurality of batteries of the first type and/or the second type, the third type of batteries being different from the first type and the second type of batteries.

9. An electric vehicle comprising:
a housing configured to interchangeably accommodate at least two different types of batteries comprising a plurality of modules provided within the body, each module comprising a plurality of batteries of a first type arranged into a first battery module that is interchangeable with a plurality of batteries of a second type arranged into a second battery module, the second type of batteries being different from the first type of batteries and the first and second battery modules comprising similar shape, the housing comprising a body having bottom side, front side, left side, right side, and back side and a lid removably connected to the body to provide access to the modules therein;
positive and negative contacts provided on the housing for connection with batteries provided in the body; and
a battery management system configured to monitor the plurality of modules,
wherein both the first type and the second type of batteries are each separately configured to supply power to the electric vehicle.

10. The electric vehicle according to claim 9, wherein the types of batteries are lithium batteries and lead acid batteries.

11. The electric vehicle according to claim 9, wherein the plurality of modules are mounted in symmetry in the housing.

12. The electric vehicle according to claim 9, wherein the plurality of modules are arranged in a parallel configuration.

13. The electric vehicle according to claim 12, wherein the batteries of each module are arranged in series.

14. The electric vehicle according to claim 9, wherein the plurality of modules provided within the housing is an even number.

15. The electric vehicle according to claim 9, further comprising padding or insulation between the plurality of modules in the housing.

16. The electric vehicle according to claim 9, wherein the housing is configured to accommodate a plurality of battery modules of a third type, each module comprising a plurality of batteries of the third type being interchangeable with the plurality of batteries of the first type and/or the second type, the third type of batteries being different from the first type and the second type of batteries.
